(19) United States
(12) Patent Application Publication
(10) Pub. No.: US 2015/0009107 A1
(43) Pub. Date: Jan. 8, 2015

(54) DISPLAY APPARATUS AND CONTROL METHOD FOR REDUCING IMAGE STICKING

(71) Applicant: SAMSUNG ELECTRONICS CO., LTD., Suwon-si (KR)

(72) Inventors: Jae-sung PARK, Seoul (KR); Min-cheol HWANG, Seoul (KR)

(73) Assignee: SAMSUNG ELECTRONICS CO., LTD., Suwon-si (KR)

(21) Appl. No.: 14/325,437

(22) Filed: Jul. 8, 2014

(30) Foreign Application Priority Data
Jul. 8, 2013 (KR) 10-2013-0079728

(51) Int. Cl. G09G 3/32

(52) U.S. Cl. CPC G09G 3/3208
USPC 345/77

(57) ABSTRACT

A display apparatus is provided. The display apparatus includes a display configured to include a plurality of pixels and to display an image frame by emitting light from the plurality of pixels by pixel, and a controller configured to adjust one of pixel brightness and a light emitting time for at least a portion of the plurality of pixels according to properties of the input image frame, and compensate the luminance of the image frame by adjusting the other one of the pixel brightness and the light emitting time to correspond to the adjusted pixel brightness or adjusted light emitting time.

### CROSS-REFERENCE TO RELATED APPLICATIONS

This application claims priority from Korean Patent Application No. 10-2013-0079728, filed on Jul. 8, 2013, in the Korean Intellectual Property Office, the disclosure of which is incorporated herein by reference, in its entirety.

### BACKGROUND

1. Technical Field

Apparatuses and methods consistent with the exemplary embodiments relate to a display apparatus and control method thereof, and a non-transitory computer-readable recording medium. More particularly, the exemplary embodiments relate to a display apparatus capable of compensating luminance of an image frame and preventing image sticking, and a control method thereof.

2. Description of the Related Art

An organic electroluminescent display apparatus is a display apparatus that electrically excites a fluorescent organic compound and thereby emits light. The organic electroluminescent display apparatus may express an image by performing voltage driving or current driving for a plurality of organic light emitting cells, which are arranged in a matrix form. The organic light emitting cells have diode characteristics, and thus are also referred to as an organic light emitting diode (OLED). Since the organic electroluminescent display apparatus may spontaneously emit light, the organic electroluminescent display apparatus does not need a separate light source. Accordingly, due to advantages such as low power consumption, high luminance, and high reaction velocity, the organic electroluminescent display apparatus is receiving attention as a next generation display apparatus. In addition, due to superior electron mobility, the organic electroluminescent display apparatus may be applied to a high-speed circuit.

However, when the organic electroluminescent display apparatus provides data for a fixed screen for a long period of time, an afterimage may be generated. In other words, in response to data not changing for a long time being provided to the organic electroluminescent display apparatus, an afterimage of the data may be left at the moment when the data changes. This after image is called image sticking.

In addition, when the organic electroluminescent display apparatus is used as a keypad of a mobile phone, text such as numbers or letters may be displayed on the keypad for a long time. Accordingly, image sticking may be a big problem.

### SUMMARY

Exemplary embodiments may overcome the above disadvantages and other disadvantages not described above. Also, the exemplary embodiments are not required to overcome the disadvantages described above, and an exemplary embodiment may not overcome any of the problems described above.

The exemplary embodiments provide a display apparatus capable of reducing image sticking without changing the luminance of an image frame, and a control method thereof.

According to an aspect of the exemplary embodiments, a display apparatus includes a display configured to include a plurality of pixels and to display an image frame by emitting light from the plurality of pixels by pixel, and a controller configured to adjust one of pixel brightness and a light emitting time for at least a portion of the plurality of pixels, according to properties of the input image frame, and compensate luminance of the image frame by adjusting the other one to correspond to the adjusted pixel brightness or light emitting time.

The controller may reduce the pixel brightness of at least the portion of the plurality of pixels, and increase the light emitting time in order to correspond to the reduced pixel brightness.

The controller may increase the light emitting time of at least the portion of the plurality of pixels, and may reduce the pixel brightness to correspond to the increased light emitting time.

The display apparatus may further include a still image determiner configured to determine whether the input image frame includes a still image. In response to the input image frame including a still image, the controller may adjust one of the pixel brightness and the light emitting time for at least the portion of the plurality of pixels.

At least the portion of the plurality of pixels may be a pixel area including the still image.

The still image may include an on-screen display (OSD) image.

The display may be implemented with an organic light emitting diode (OLED).

According to another aspect of the exemplary embodiments, a method of controlling a display apparatus, including a display configured to include a plurality of pixels, is provided to display an image frame by emitting light from the plurality of pixels by pixel including adjusting one of pixel brightness and a light emitting time for at least a portion of the plurality of pixels, according to properties of the input image frame, and compensating luminance of the image frame to display on the display, by adjusting the other one to correspond to the adjusted pixel brightness or light emitting time.

In the adjusting operation, the pixel brightness of at least the portion of the plurality of pixels may be reduced, and the light emitting time may be increased to correspond to the reduced pixel brightness.

In the adjusting operation, the light emitting time of at least the portion of the plurality of pixels may be increased, and the pixel brightness may be reduced to correspond to the increased light emitting time.

The control method may further include determining whether the input image frame includes a still image. In the adjusting operation, when the input image frame includes a still image, one of the pixel brightness and the light emitting time may be adjusted for at least the portion of the plurality of pixels.

The at least the portion of the plurality of pixels may be a pixel area including the still image.

The still image may include an on-screen display (OSD) image.

The display may be implemented with an organic light emitting diode (OLED).

According to the aforementioned diverse exemplary embodiments, image sticking may be prevented, and at the same time, luminance of the image frame may be compensated.

As aspect of the exemplary embodiments may provide a display apparatus for reducing image sticking without changing luminance of an image frame, the display apparatus including: a controller configured to adjust one of pixel brightness and a light emitting time for at least a portion of a plurality of pixels according to properties of an input image frame, and compensate luminance of the image frame by adjusting the other one of the pixel brightness and light emitting time in order to correspond to the adjusted pixel brightness or adjusted light emitting time.

The display apparatus may further include a display configured to include a plurality of pixels and display the image frame by emitting light from the plurality of pixels.

The controller may be configured to reduce the pixel brightness of at least the portion of the plurality of pixels, and increase the light emitting time to correspond to the reduced pixel brightness.

The controller may be configured to increase the light emitting time of at least the portion of the plurality of pixels, and reduce the pixel brightness to correspond to the increased light emitting time.

The display apparatus may further include: a still image determiner configured to determine whether the input image frame includes a still image, wherein in response to the input image frame including a still image, the controller is configured to adjust one of the pixel brightness and the light emitting time for at least the portion of the plurality of pixels.

The at least the portion of the plurality of pixels is a pixel area which includes the still image.

Additional and/or other aspects and advantages of the exemplary embodiments will be set forth in part in the description which follows, and, in part, will be obvious from the description, or may be learned by practice of the exemplary embodiments.

### BRIEF DESCRIPTION OF THE DRAWING FIGURES

The above and/or other aspects will be more apparent by describing certain exemplary embodiments, with reference to the accompanying drawings, in which:

FIG. 1 is a block diagram of a display apparatus according to an exemplary embodiment;

FIG. 2 is a screen of a display provided to describe the exemplary embodiments;

FIGS. 3A and 3B are graphs provided to describe the exemplary embodiments;

FIGS. 4 and 5 are driving timing diagrams of a display apparatus provided to describe the exemplary embodiments;

FIG. 6 is a block diagram of a display apparatus according to another exemplary embodiment;

FIG. 7 is a circuit diagram showing a configuration of a pixel area shown in FIG. 6; and

FIG. 8 is a flow chart of a method of controlling a display apparatus, according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements, even in different drawings. The matters defined in the description, such as a detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

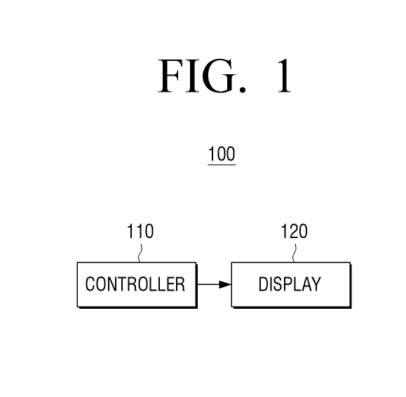

FIG. 1 is a block diagram of a display apparatus 100 according to an exemplary embodiment.

With reference to FIG. 1, the display apparatus 100 may include a display 120 and a controller 110.

The display 120 may include a plurality of pixels. In response to the plurality of pixels emitting light, an image is displayed. The display 120 displays an image frame by emitting light by pixel. A screen displayed by the display 120 may be controlled by the controller 110. In this case, the display 120 may be implemented as an organic light emitting diode (OLED).

The controller 110 receives a signal for an image frame to be displayed on the screen, control the signal, and transmit the signal to the display 120. In this case, the controller 110 compensates for the luminance of the image frame by adjusting one of pixel brightness and a light emitting time for at least a portion of the plurality of pixels, according to properties of the input image frame and adjusting the other one of pixel brightness and light emitting time in order to correspond to the adjusted pixel brightness or the light emitting time.

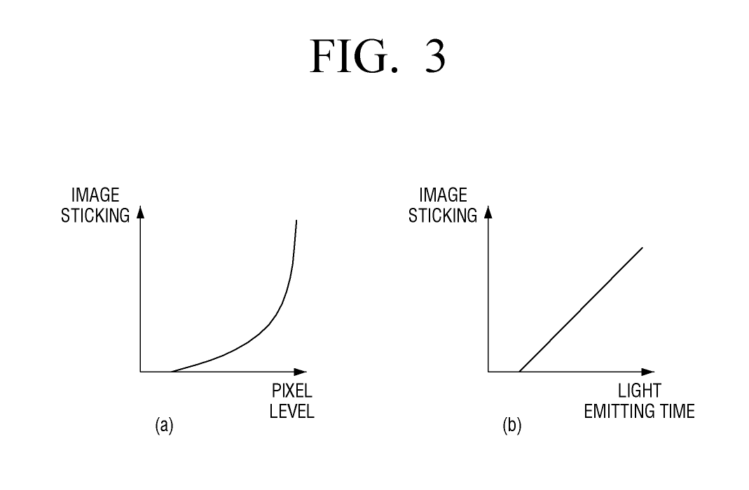

More specifically, the controller 110 may reduce the pixel brightness for a portion or all of the plurality of pixels, and increase a light emitting time to correspond to the reduced pixel brightness. In the same manner, the controller 110 may increase a light emitting time, and reduce the pixel brightness for a portion or all of the plurality of pixels in order to correspond to the increased light emitting time. In other words, pixel brightness, which is a major cause of image sticking, that is, a pixel level, is reduced and a light emitting time is increased accordingly so that the reduced pixel level may be compensated. Accordingly, image sticking may be reduced. This will be described in greater detail with reference to FIGS. 3 to 5.

The display apparatus 100 consistent with an exemplary embodiment may further include a still image determiner.

An image frame input to the controller 110 may be a still image, a moving image, or a moving image which includes a still image. Accordingly, the still image determiner may determine whether the input image frame is a still image frame or a moving image which includes a still image. In response to the input image frame being a moving image frame which includes a still image, at least a portion of the plurality of pixels may be a pixel area which includes a still image. In addition, when the entire input image frame is a still image frame, all of the plurality of pixels may be a pixel area which includes a still image. In response to a moving image including a still image being a single image frame, the still image frame is an on-screen display (OSD) image. In addition, the still image is not limited to the OSD, but may be input through a keypad used for devices such as a smart television and a smart phone.

The still image determiner may transmit to the controller 110 information regarding a pixel area which is determined to be a still image in the input image frame. The controller 110 receives the information regarding the pixel area which corresponds to the still image and controls the display 120 based on the received information.

More specifically, the controller 110 may reduce the brightness of the pixel area which corresponds to the still image from among the plurality of pixels, and increase a light emitting time of the pixel area which corresponds to the still image in order to correspond to the reduced pixel brightness. Alternatively, the controller 110 may increase a light emitting time of the pixel area which corresponds to the still image, from among the plurality of pixels, and reduce the brightness of the pixel area which corresponds to the still image, in order to correspond to the increased light emitting time. Accordingly, the pixel brightness of the still image, that is, a pixel level, is reduced and the light emitting time is accordingly increased to compensate for the reduced pixel level. As a result, image sticking may be reduced.

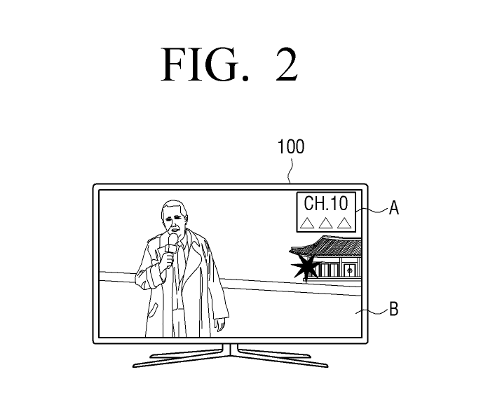

FIG. 2 is a screen of the display 120 provided to describe the exemplary embodiments.

The screen composed by the display 120 may display an image frame as described above. In this case, the image frame may be a still image, a moving image, a still image which is part of a moving image, or a moving image including a still image. FIG. 2 shows an image frame of moving image B which includes still image A.

With reference to FIG. 2, the input image frame is moving image B which includes, in part, still image A. When the input image frame is moving image B, the brightness of the plurality of pixel areas changes according to the input image frame. Accordingly, image sticking may not occur in pixels where the brightness changes according to the image frame. However, when the input image frame remains still image A, the brightness of a pixel area which corresponds to still image A does not change according to the input image frame. Accordingly, image sticking may occur in pixels where the brightness does not change according to the image frame. That is, in order to prevent image sticking, the controller 110 controls the display 120 with respect to the pixel area which corresponds to still image A, but does not control the display with respect to the pixel area which corresponds to moving image B.

Therefore, the still image determiner may determine the pixel area which corresponds to still image A from the input image frame, and may transmit to the controller 110 information regarding the pixel area which is determined to be still image A. The controller 110 receives the information regarding the pixel area which corresponds to still image A, and controls the display 120 based on the received information. That is, the controller 110 may control the display 120 to reduce the brightness of the pixel area which corresponds to still image A, from among the plurality of pixels, and to increase a light emitting time of the pixel area which corresponds to still image A to correspond to the reduced pixel brightness. Alternatively, the controller 110 may control the display 120 to increase a light emitting time of the pixel area which corresponds to still image A, from among the plurality of pixels, and to reduce the brightness of the pixel area corresponding to still image A in order to correspond to the increased light emitting time.

FIGS. 3A and 3B are graphs provided to describe the exemplary embodiments.

With reference to FIGS. 3A and 3B, the incidence of image sticking according to the increase of pixel level or the increase of a light emitting time of a pixel, is shown. As the pixel level, that is, the brightness of a pixel increases, the incidence of image sticking increases as shown in FIG. 3A. In addition, as a light emitting time of a pixel increases, the incidence of image sticking increases as shown in FIG. 3B. However, it is shown that the brightness of the pixel affects image sticking more than the light emitting time. In other words, in response to the brightness of the pixel being reduced, the incidence of image sticking is sharply reduced. The reduced brightness of the pixel is compensated for by increasing the light emitting time of the pixel. Accordingly, in response to the brightness of the pixel being reduced and the light emitting time of the pixel is increased to correspond to the reduced brightness of the pixel, the incidence of image sticking may be reduced and the brightness of the pixel may be compensated for.

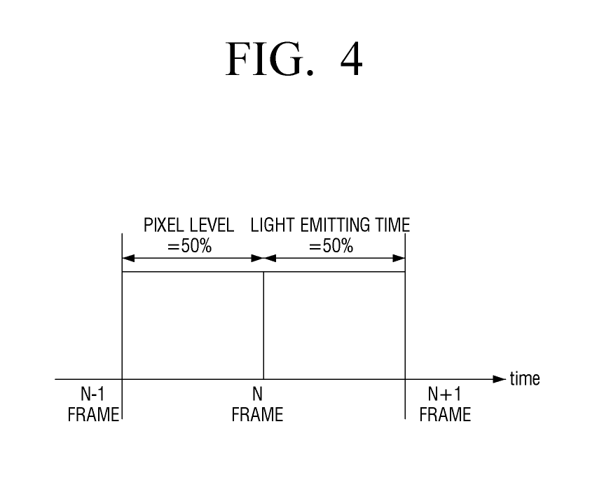

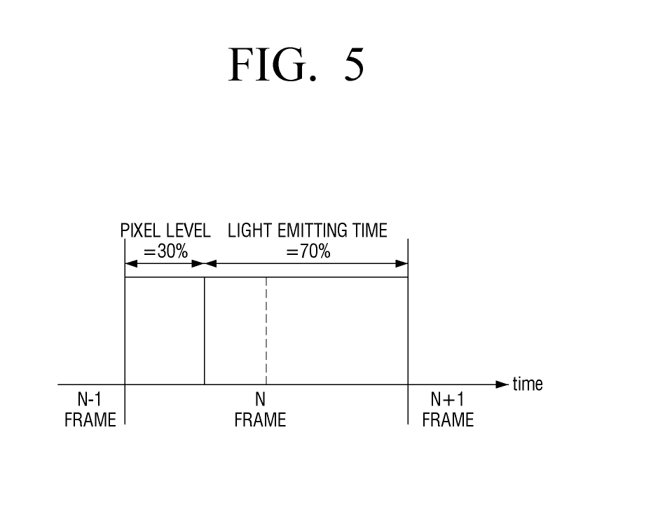

The light emitting time of the pixel which corresponds to the reduced pixel level will now be explained in greater detail. FIGS. 4 and 5 are driving timing diagrams of the display apparatus 100 which are provided to describe the exemplary embodiments. Here, the ratio of a general level of a pixel to a light emitting time for an image frame is not an absolute figure but rather is a relative figure. It is clear that specific figures of the pixel level and the light emitting time shown in FIGS. 4 and 5 are merely example to describe the exemplary embodiments.

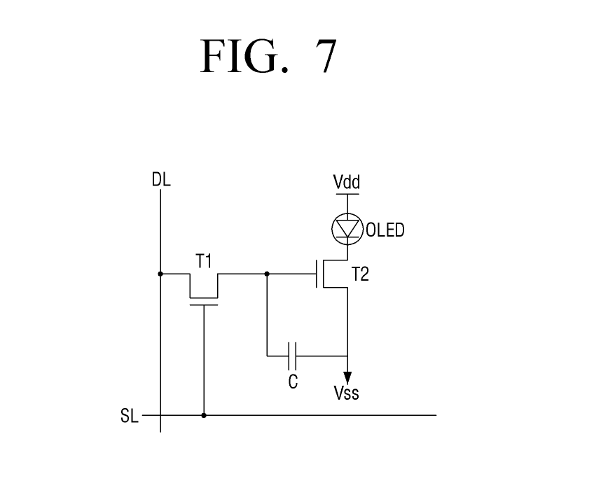

FIG. 4 shows general pixel level and light emitting time of a pixel for each image frame. Although shown with reference to FIG. 7, an OLED generally includes at least one capacitor which is also referred to as a storage capacitor (C). The function of the storage capacitor (C) may be maximized when Simultaneous Emission with Active Voltage (SEAV) in which all of the OLEDs emit light at the same time after scanning each pixel is complete, is applied.

With reference to FIG. 4, a term of a single frame in the SEAV method includes a scanning time to transmit and program a plurality of data signals to all the pixels, the data signals, and a light emitting time for each of the pixels to emit light, according to the programmed data signal after completing programming of the data signals to all of the pixels. That is, in the SEAV method, data signals are sequentially input but light emission is performed in a lump after input of the data signals is complete.

For example, as shown in FIG. 4, a 50% pixel level for a single image frame may indicate that a scanning time to transmit and program a plurality of data signals to all the pixels is 50% per single frame. However, in response to the scanning time being reduced to 30%, as shown in FIG. 5, this may indicate that the pixel level, that is, the brightness of the pixel, is reduced. Accordingly, the incidence of image sticking may be dramatically reduced to as much as the amount of reduction of the reduced pixel level. This was described above with reference to FIG. 3.

Even though the incidence of image sticking is reduced by reducing the pixel level, the reduced pixel level needs to be compensated. In other words, since visibility of the user cannot be given up in order to reduce image sticking, the reduced pixel level may be compensated by increasing the light emitting time corresponding to the reduced pixel level. With reference to FIG. 5, the pixel level is reduced by 20% in comparison with FIG. 4, but the light emitting time is increased by 20% to correspond to the reduced pixel level. That is, the reduced pixel level may be compensated by increasing the light emitting time of the pixel for the single image frame.

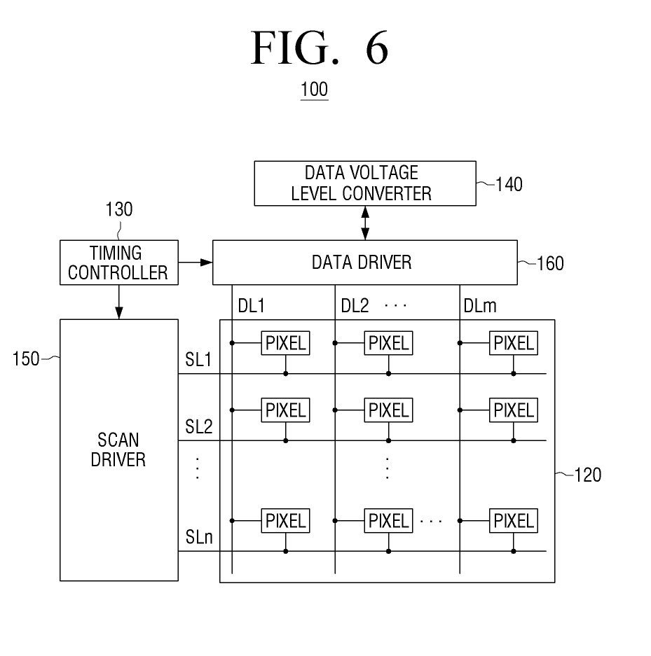

The display apparatus 100 consistent with another exemplary embodiment and a driving method thereof are described below, in greater detail, with reference to the drawings. FIG. 6 is a block diagram of the display apparatus 100 according to another exemplary embodiment. FIG. 7 is a circuit diagram showing a configuration of a pixel area shown in FIG. 6.

With reference to FIG. 6, the display apparatus 100 may include a display 120 in which a plurality of scan lines SL1, SL2, . . . , SLn and a plurality of data lines DL1, DL2, . . . , DLm intersect each other, a scan driver 150 which supplies a scan signal to the plurality of scan lines SL1, SL2, . . . , and SLn, a data driver 160 which supplies data voltage to the plurality of data lines DL1, DL2, . . . , and DLm, a timing controller 130 which controls the scan driver 150 and the data driver 160, and a data voltage level converter 140 which converts level of data voltage.

In the display 120, the plurality of scan lines SL1, SL2, . . . , and SLn are provided in one direction, and the plurality of data lines DL1, DL2, . . . , and DLm are provided at right angles to the plurality of scan lines SL1, SL2, . . . , and SLn. A plurality of pixel areas are defined by the intersection of the scan lines and the data lines.

In each pixel area as shown in FIG. 7, a switching transistor T1 is provided at intersections where the scan lines SL1, SL2, . . . , and SLn and the data lines DL1, DL2, . . . , and DLm cross, a storage capacitor C is provided to be connected to the switching transistor T1, and a driving transistor T2 is provided to be connected to a joint of the switching transistor T1 and the storage capacitor C and to the data lines DL1, DL2, . . . , and DLm. In addition, the driving transistor T2 is connected to base voltage Vss, and the base voltage Vss is connected to power voltage Vdd through an OLED of constant current driving type.

More specifically, the switching transistor T1 is turned on by a scan signal applied from the scan driver 150, and then transmits data voltage applied through the data lines DL1, DL2, . . . , and DLm.

The driving transistor T2 is turned on by the data voltage applied through the data lines DL1, DL2, . . . , and DLm, and generates driving current which corresponds to the difference between the data voltage and the power voltage Vdd.

The storage capacitor C temporarily stores the data voltage applied through the data lines DL1, DL2, . . . , and DLm, and the OLED spontaneously emits light using the driving current generated by the driving transistor T2.

When the display 120, having a configuration as described above is driven, scan signals are sequentially applied to the scan lines SL1, SL2, . . . , and SLn, and data voltage in synchronization with the scan signal is applied to the data lines DL1, DL2, . . . , and DLm, at the same time. Accordingly, when the scan signal input through the scan lines SL1, SL2, . . . , and SLn is applied to a gate of the switching transistor T1, the switching transistor T1 is turned on, and the data voltage passes through the switching transistor T1 and are applied to the driving transistor T2 and the storage capacitor C. Subsequently, the driving transistor T2 is turned on by the data voltage, generates driving current, and supplies the driving current to the OLED so that the OLED may spontaneously emit light.

The timing controller 130 supplies digital image data to the data driver 160, and generates a control signal to control the scan driver 150 and the data driver 160 using a synchronization signal and a main clock. Since the timing controller 130 is connected to the controller 110, the control signal generated by the timing controller 130 may reflect a pixel level and a light emitting time which are controlled by the controller 110. In other words, a pixel level and a light emitting time controlled by the controller 110 may be supplied to the data driver 160 and the scan driver 150 as a control signal generated by the timing controller 130.

The scan driver 150 generates a scan signal in response to the control signal from the timing controller 130, sequentially supplies the scan signal to the scan lines SL1, SL2, . . . , and SLn, and thereby selects a horizontal line of the display 120 to supply a data signal.

The data driver 160 converts a digital image signal into analog gamma compensation voltage in response to the control signal from the timing controller 130, and supplies the analog gamma compensation voltage to the data lines DL1, DL2, . . . , and DLm of the display 120 as the data voltage.

The data voltage level converter 140 converts a level of data voltage applied to the data driver 160. The data voltage is voltage of digital form which corresponds to a black screen, but is not limited thereto. The data voltage converted by the data voltage level converter 140 is again converted into analog gamma compensation voltage by the data driver 160 and is then supplied to the data lines DL1, DL2, . . . , and DLm of the display 120.

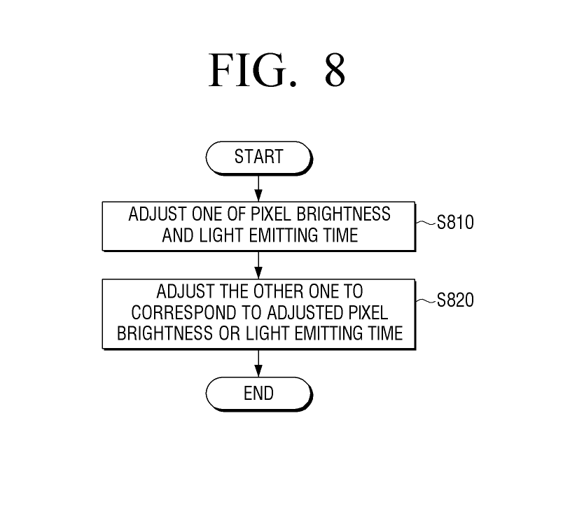

FIG. 8 is a flow chart of a control method of the display apparatus 100 according to an exemplary embodiment.

With reference to FIG. 8, a signal is input for an image frame. The controller 110 controls the input signal for the image frame, and transmits the input signal to the display 120. The display 120 may display the image frame by emitting light from a plurality of pixels by pixel. The display 120 may be implemented as an OLED.

In this case, after the signal for the image frame is input, the brightness of a pixel is adjusted (S810). In other words, the brightness of a pixel for the input single image frame is reduced. Since a major cause of generating image sticking is the brightness of a pixel, that is, a pixel level, image sticking may be reduced by decreasing the pixel level of the image frame.

However, in response to the pixel level decreasing, visibility to the user also decreases. Thus, there is a need to compensate for the reduced pixel level. Accordingly, a light emitting time of the pixel may increase in order to correspond to the reduced pixel level (S820). Therefore, image sticking may be reduced by decreasing the pixel level, and visibility may be secured by increasing the light emitting time of the pixel in order to correspond to the reduced pixel level.

Similarly, after a signal for an image frame is input, a light emitting time of a pixel is adjusted (S810). That is, a light emitting time of a pixel for the input signal image frame increases. The brightness of the pixel may be reduced to correspond to the increased light emitting time (S820). Therefore, image sticking may be reduced by decreasing the pixel level, and visibility may be secured by increasing the light emitting time of the pixel to correspond to the reduced pixel level.

A program to perform the methods according to the diverse exemplary embodiments may be stored in diverse types of recording media and be used.

More specifically, a code to perform the methods may be stored in diverse types of recording media which are readable by terminal devices, such as a random-access memory (RAM), a flash memory, a read-only memory (ROM), an erasable programmable ROM (EPROM), an electrically erasable and programmable ROM (EEPROM), a register, a hard disk, a removable disk, a memory card, a universal serial bus (USB) memory, and a CD-ROM.

The foregoing exemplary embodiments and advantages are merely exemplary and are not to be construed as limiting. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to include a plurality of pixels and display an image frame by emitting light from the plurality of pixels by pixel; and
a controller configured to adjust one of pixel brightness and a light emitting time for at least a portion of the plurality of pixels according to properties of the input image frame, and compensate luminance of the image frame by adjusting the other one of the pixel brightness and light emitting time in order to correspond to the adjusted pixel brightness or adjusted light emitting time.

2. The display apparatus as claimed in claim 1, wherein the controller is configured to reduce the pixel brightness of at least the portion of the plurality of pixels, and increase the light emitting time to correspond to the reduced pixel brightness.

3. The display apparatus as claimed in claim 1, wherein the controller is configured to increase the light emitting time of at least the portion of the plurality of pixels, and reduce the pixel brightness to correspond to the increased light emitting time.

4. The display apparatus as claimed in claim 1, further comprising:
a still image determiner configured to determine whether the input image frame includes a still image,
wherein in response to the input image frame including a still image, the controller adjusts one of the pixel brightness and the light emitting time for at least the portion of the plurality of pixels.

5. The display apparatus as claimed in claim 4, wherein the at least the portion of the plurality of pixels is a pixel area which includes the still image.

6. The display apparatus as claimed in claim 4, wherein the still image includes an on-screen display (OSD) image.

7. The display apparatus as claimed in claim 1, wherein the display is implemented as an organic light emitting diode (OLED).

8. A method of controlling a display apparatus comprising a display configured to include a plurality of pixels and display an image frame by emitting light from the plurality of pixels by pixel, the control method comprising:
adjusting one of pixel brightness and a light emitting time for at least a portion of the plurality of pixels, according to properties of the input image frame; and
compensating luminance of the image frame to display on the display by adjusting the other one of the pixel brightness and a light emitting time to correspond to the adjusted pixel brightness or adjusted light emitting time.

9. The control method as claimed in claim 8, wherein in the adjusting operation, the pixel brightness of at least the portion of the plurality of pixels is reduced, and the light emitting time is increased to correspond to the reduced pixel brightness.

10. The control method as claimed in claim 8, wherein in the adjusting operation, the light emitting time of at least the portion of the plurality of pixels is increased, and the pixel brightness is reduced to correspond to the increased light emitting time.

11. The control method as claimed in claim 8, further comprising:
determining whether the input image frame includes a still image,
wherein in the adjusting operation, in response to the input image frame including a still image, one of the pixel brightness and the light emitting time is adjusted for at least the portion of the plurality of pixels.

12. The control method as claimed in claim 11, wherein at least the portion of the plurality of pixels is a pixel area including the still image.

13. The control method as claimed in claim 11, wherein the still image includes an on-screen display (OSD) image.

14. The control method as claimed in claim 8, wherein the display is implemented as an organic light emitting diode (OLED).

15. A display apparatus for reducing image sticking without changing luminance of an image frame, the display apparatus comprising:
a controller configured to adjust one of pixel brightness and a light emitting time for at least a portion of a plurality of pixels according to properties of an input image frame, and compensate luminance of the image frame by adjusting the other one of the pixel brightness and light emitting time in order to correspond to the adjusted pixel brightness or adjusted light emitting time.

16. The display apparatus of claim 15, further comprising a display configured to include a plurality of pixels and display the image frame by emitting light from the plurality of pixels.

17. The display apparatus of claim 16, wherein the controller is configured to reduce the pixel brightness of at least the portion of the plurality of pixels, and increase the light emitting time to correspond to the reduced pixel brightness.

18. The display apparatus as claimed in claim 16, wherein the controller is configured to increase the light emitting time of at least the portion of the plurality of pixels, and reduce the pixel brightness to correspond to the increased light emitting time.

19. The display apparatus as claimed in claim 15, further comprising:
a still image determiner configured to determine whether the input image frame includes a still image,
wherein in response to the input image frame including a still image, the controller is configured to adjust one of the pixel brightness and the light emitting time for at least the portion of the plurality of pixels.

20. The display apparatus as claimed in claim 19, wherein the at least the portion of the plurality of pixels is a pixel area which includes the still image.
